(19) United States
(12) Patent Application Publication
(10) Pub. No.: US 2024/0145688 A1
(43) Pub. Date: May 2, 2024

(54) COMPOSITE POSITIVE ELECTRODE MATERIAL AND PREPARATION METHOD THEREFOR, AND LITHIUM ION BATTERY

(71) Applicant: INSTITUTE OF PROCESS ENGINEERING, CHINESE ACADEMY OF SCIENCES, Beijing (CN)

(72) Inventors: Qiangqiang TAN, Beijing (CN); Xueqian JI, Beijing (CN)

(21) Appl. No.: 18/565,818

(22) PCT Filed: Jul. 6, 2021
(86) PCT No.: PCT/CN2021/104708

§ 371 Date: Nov. 30, 2023

(30) Foreign Application Priority Data
Jun. 10, 2021 (CN) 202110646725.8

(51) Int. Cl. H01M 4/36; C01G 53/00; H01M 4/485; H01M 4/505; H01M 4/525; H01M 10/0525

(52) U.S. Cl. CPC H01M 4/366; C01G 53/50; H01M 4/485; H01M 4/505; H01M 4/525; H01M 10/0525; H01M 2004/028

(57) ABSTRACT

The present application provides a composite positive electrode material and a preparation method therefor, and a lithium ion battery. The positive electrode material comprises a core and a cladding layer cladded on the surface of the core, the core comprises a lithium-rich positive electrode material, and the cladding layer comprises an n-type thermoelectric material. The method comprises: compounding the lithium-rich positive electrode material with the n-type thermoelectric material to obtain the composite positive electrode material. The compounding method comprises: method I, mixing the lithium-rich positive electrode material with the n-type thermoelectric material for treatment to obtain the composite positive electrode material; or method II, dispersing and treating raw materials of the lithium-rich positive electrode material and the n-type thermoelectric material to obtain the composite positive electrode material.

### TECHNICAL FIELD

The present application belongs to the technical field of batteries and relates to a composite cathode material and a preparation method therefor and a lithium-ion battery.

### BACKGROUND

As there are increasing demands for energy, the mainstream cathode materials for lithium-ion batteries in the current market, such as LiCO₂, LiNiO₂, ternary materials, LiMn₂O₄ and LiFePO₄, will not be able to meet the needs in the future. Therefore, it is an urgent need to find a cathode material with high energy density for the lithium-ion batteries. The lithium-rich cathode material of xLi₂MnO₃·(1−x)LiAO₂ (A=Co, Ni, Cr or Fe) has high specific capacity, high working voltage, low price and environmental friendliness and has been widely studied. However, the stability of lithium-rich cathode material is poor, because of which the lithium-rich cathode material cannot meet the market demand for fast charging and fast discharging. It has been found through the research that at the high charging plateau, the lithium-rich material undergoes transition metal migration due to lithium ion de-intercalation and oxygen loss, and transforms to the more stable spinel structure with lower energy, and the electrical work consumed is dissipated in the form of heat (Assat, 2019, Nature Energy). The generation of heat in the battery makes the battery less safe, and also much electrical work is consumed, reducing the energy efficiency. Most importantly, the dissipated heat accelerates the transition of the system's layered structure to the spinel structure, and the stability of the electrochemical performance of the material is reduced.

Researchers have made great efforts to timely transfer the generated heat away. For example, CN106229580A discloses a heat dissipation material for lithium-ion traction batteries; this method can alleviate the localized heat generation in lithium-ion batteries, but reduces the diffusion efficiency of lithium ions due to the low ionic conductivity. CN105185966A discloses a heat dissipation material for lithium-ion traction batteries; in this method, the cathode and anode of the lithium-ion traction battery are combined with p-type and n-type thermoelectric materials, respectively; although this method has the effect of heat dissipation, the thermoelectric potential generated impedes the diffusion of lithium ions; besides, the thermoelectric material used in this patent is easy to be oxidized and decomposed to produce heavy metals which are harmful to the environment. Yanyan Zuo et al. (Yanyan Zuo, 2020, Power supply technology research and design) designed a phase change material—thermal conductive medium—forced air convection lithium battery composite heat dissipation system, Xiaoguang Zhang et al. (Xiaoguang Zhang, 2020, Mechanical and electronic) established a heat dissipation model for a single cylinder lithium battery coupled with the phase change materials, and Shangshang Hu et al. (Shangshang Hu, 2020, Chemical Progress) used an organic alcohols phase change material (tetradecanol) for heat dissipation in the discharge process of soft-clad square lithium batteries. These designs and modifications facilities the heat dissipation of batteries and maintains the normal operating temperature and temperature uniformity, but the structural problem of lithium cathode materials is not fundamentally solved.

### SUMMARY

An object of the present application is to provide a composite cathode material, a preparation method therefor and a lithium-ion battery. The composite cathode material provided in the present application can increase the lithium-ion diffusion rate, improve the stability, and at the same time inhibit the corrosion of electrolyte on the lithium-rich cathode material and improve the cycle stability of the battery.

To achieve the object, the present application adopts the technical solutions below.

In a first aspect, the present application provides a composite cathode material, and the cathode material comprises a core and a coating layer coated on the core, wherein the core comprises a lithium-rich cathode material, and the coating layer comprises an n-type thermoelectric material.

The composite cathode material provided in the present application is prepared by combining the lithium-rich cathode material with the thermoelectric material. The electrical work, which is consumed by the lithium-rich cathode material via the metastable path at high-voltage plateau, is dissipated in the form of heat, and the layer of n-type thermoelectric material coated on the surface of lithium-rich cathode material will transform the consumed heat into a localized electric field having the same direction of the external electric field, which can increase the lithium-ion diffusion rate and improve the stability. Meanwhile, the corrosion of electrolyte on the lithium-rich cathode material is inhibited, and the cycle stability of the battery is improved.

The following is optional technical solutions of the present application but is not a limitation of the technical solutions provided in the present application. The technical purposes and beneficial effects of the present application can be better achieved and realized by the following optional technical solutions.

As an optional technical solution of the present application, the lithium-rich cathode material has a structural formula of xLi₂MnO₃-(1−x)LiMO₂, wherein M is any one or a combination of at least two of Co, Ni, Fe, K, V, Cr, Ge, Nb, Mo, Zr, Al Sr, Mg or Ti, and 0<x≤1, and for example, x is 0.1, 0.2, 0.5, 0.8 or 1.

Optionally, the M is a combination of Co, Ni and Mn.

Optionally, the n-type thermoelectric material has lithium-ion diffusion channels. The lithium-ion diffusion channels are transport channels for lithium ions.

Optionally, the n-type thermoelectric material comprises any one or a combination of at least two of LiₐP_{b}NbO₂, (Nd_{2/3-c}Li_{3c})TiO₃, (La_{2/3-c}Li_{3c})TiO₃ or CaₑBi_{f}MnO₃; wherein for the LiₐP_{b}NbO₂, 0<a<0.4 and 0<b<0.2; for the (Nd_{2/3-c}Li_{3c})TiO₃ and (La_{2/3-c}Li_{3c})TiO₃, 0.2<c<2/3; for the CaₑBi_{f}MnO₃, 0.5<e≤1 and 0≤f<0.5.

Optionally, a mass ratio of the n-type thermoelectric material to the lithium-rich cathode material is (0.01-0.5): 1, such as 0.01:1, 0.05:1, 0.1:1, 0.2:1, 0.3:1, 0.4:1 or 0.5:1. In the present application, if the n-type thermoelectric material is too much, the specific capacity will be reduced; if the n-type thermoelectric material is too little, the coating layer will be uneven, and the heat released during the reaction process cannot be efficiently converted into electrical energy.

In a second aspect, the present application provides a preparation method for the composite cathode material as described in the first aspect, and the method comprises the following steps:
combining the lithium-rich cathode material with the n-type thermoelectric material to obtain the composite cathode material; a method of the combination comprises Method I: mixing the lithium-rich cathode material with the n-type thermoelectric material and treating, so as to obtain the composite cathode material;
or Method II: dispersing and treating the lithium-rich cathode material and a raw material of the n-type thermoelectric material, so as to obtain the composite cathode material.

The preparation method provided in the present application has a facile operation and a short process, and it is suitable for large-scale industrial production. For the method of the combination, Method I has an advantage of accurate quantification of the coating amount; and Method II has an advantage of uniform coating.

As an optional technical solution of the present application, the preparation method for the lithium-rich cathode material comprises: adding a chelating agent to a solution containing a lithium source, a manganese source and an M source to obtain a mixed solution, heating and stirring to obtain a sol, and drying and calcining the sol to obtain the lithium-rich cathode material.

Optionally, in the preparation method for the lithium-rich cathode material, a molar ratio of the lithium source to the manganese source to the M source is (1+x): x:(1−x), wherein 0<x≤1, and for example, x is 0.1, 0.2, 0.5, 0.8 or 1.

Optionally, in the preparation method for the lithium-rich cathode material, the M source comprises any one or a combination of at least two of cobalt, nickel, iron, potassium, vanadium, chromium, germanium, niobium, molybdenum, zirconium, aluminium, strontium, magnesium or titanium.

Optionally, the M source is any one or a combination of at least two of sulfate, chloride, acetate or nitrate.

Optionally, in the preparation method for the lithium-rich cathode material, the lithium source comprises any one or a combination of at least two of lithium carbonate, lithium hydroxide, lithium nitrate or lithium acetate.

Optionally, in the preparation method for the lithium-rich cathode material, the manganese source comprises any one or a combination of at least two of manganese chloride, manganese nitrate, manganese oxalate, manganese acetate, manganese sulfate or potassium permanganate.

Optionally, in the preparation method for the lithium-rich cathode material, for the solution containing the lithium source, the manganese source and the M source, a solvent comprises any one or a combination of at least two of water, ethanol or an aqueous solution of hydrogen peroxide.

Optionally, in the preparation method for the lithium-rich cathode material, the chelating agent is any one or a combination of at least two of amine, amide or citric acid, optionally a combination of amine and amide. In the present application, the purpose of using the chelating agent in the process of preparing the lithium-rich cathode material is to form a three-dimensional network structure to facilitate a uniform particle size of the material.

Optionally, the amine comprises at least one of N-isopropyl-2,4-dichlorobenzylamine, cyclohexanecarboxamide or N,N-dimethylhexahydropyridine.

Optionally, the amide is at least one of N,N-dimethylformamide, N,N-dimethylacetamide, succinimide or benzamide.

Optionally, in the combination of amine and amide, a volume ratio of amine to amide is 1:3-3:1, such as 1:3, 1:2, 1:1, 1:2 or 1:3. In the combination of amine and amide, too much amine will lead to overly strong alkalinity of the solution and cause the generation of precipitates; too much amide will lead to failure to form the three-dimensional network structure.

As an optional technical solution of the present application, in the preparation method for the lithium-rich cathode material, the heating is performed at a temperature of 40-100° C., such as 40° C., 50° C., 60° C., 70° C., 80° C., 90° C. or 100° C., optionally 60-80° C.

Optionally, in the preparation method for the lithium-rich cathode material, the stirring is magnetic stirring and/or mechanical stirring.

Optionally, in the preparation method for the lithium-rich cathode material, the stirring is performed at a rotational speed of 200-500 rpm/min, such as 200 rpm/min, 300 rpm/min, 400 rpm/min or 500 rpm/min.

Optionally, in the preparation method for the lithium-rich cathode material, the stirring is performed for a period of 4-8 h, such as 4 h, 5 h, 6 h, 7 h or 8 h.

Optionally, in the preparation method for the lithium-rich cathode material, the drying comprises blast drying and/or vacuum drying.

Optionally, in the preparation method for the lithium-rich cathode material, the drying is performed at a temperature of 80-150° C. for a period of 5-20 h.

Optionally, in the preparation method for the lithium-rich cathode material, the calcining is heating to 200-700° C., such as 200° C., 300° C., 400° C., 500° C., 600° C. or 700° C., and sintering for 1-15 h, such as 1 h, 5 h, 10 h or 15 h, wherein a heating rate is 1-10° C./min, such as 1° C./min, 2° C./min, 5° C./min, 8° C./min or 10° C./min, and then heating to 800-1000° C., such as 800° C., 900° C. or 1000° C., and sintering for 10-24 h, such as 10 h, 15 h, 20 h or 24 h, wherein a heating rate is 3-8° C./min, such as 3° C./min, 4° C./min, 5° C./min, 6° C./min, 7° C./min or 8° C./min.

Optionally, in the preparation method for the lithium-rich cathode material, the calcining is heating to 350-650° C. at a heating rate of 1-2° C./min and sintering for 2-10 h, then heating to 800-950° C. at a heating rate of 3-8° C./min and sintering for 10-24 h.

Optionally, in the preparation method for the lithium-rich cathode material, the calcining is performed in an air atmosphere and/or an oxygen atmosphere.

As an optional technical solution of the present application, in Method I, a preparation method for the n-type thermoelectric material comprises: ball milling and mixing a raw material of the n-type thermoelectric material, drying, and calcining, so as to obtain the n-type thermoelectric material.

Optionally, in the preparation method for the n-type thermoelectric material, the ball milling comprises one of dry ball milling, wet ball milling, high-energy ball milling or cryo-ball milling.

Optionally, in the preparation method for the n-type thermoelectric material, the ball milling is performed at a rotational speed of 200-2000 rpm/min, such as 200 rpm/min, 500 rpm/min, 1000 rpm/min, 1500 rpm/min or 2000 rpm/min.

Optionally, in the preparation method for the n-type thermoelectric material, the ball milling is performed for a period of 2-48 h, such as 2 h, 10 h, 20 h, 30 h, 40 h or 48 h, optionally 2-12 h.

Optionally, in the preparation method for the n-type thermoelectric material, the drying comprises at least one of blast drying, vacuum drying or freeze drying.

Optionally, in the preparation method of the n-type thermoelectric material, the drying is performed at a temperature of 60-120° C., such as 60° C., 70° C., 80° C., 90° C., 100° C., 110° C. or 120° C., and the drying is performed for a period of 8-24 h, such as 8 h, 10 h, 15 h, 20 h or 24 h.

Optionally, in the preparation method for the n-type thermoelectric material, the calcining is performed at 500-900° C., such as 500° C., 600° C., 700° C., 800° C. or 900° C., the calcining is performed for 2-10 h, such as 2 h, 3 h, 4 h, 5 h, 6 h, 7 h, 8 h, 9 h or 10 h.

Specifically, the preparation method for LiₐP_{b}NbO₂ is ball-milling and mixing a Li source, a P source and a Nb source, then drying and calcining.

The preparation method for (Nd_{2/3-c}Li_{3c})TiO₃ is ball-milling and mixing a Li source, a Nb source and a Ti source, then drying and calcining.

The preparation method for (La_{2/3-c}Li_{3c})TiO₃ is ball-milling and mixing a Li source, a La source and a Ti source, then drying and calcining.

The preparation method for CaₑBi_{f}MnO₃ is ball-milling and mixing a Ca source, a Mn source and a Bi source, then drying and calcining.

Optionally, the Li source is one or more of lithium carbonate, lithium hydroxide, lithium nitrate, lithium acetate and lithium oxalate.

Optionally, the P source is one of phosphorus pentoxide, phosphorus trihalide and phosphorus pentahalide.

Optionally, the Nb source is one or more of niobium metal, niobium pentoxide, niobium fluoride, niobium chloride and tris(nitrooxy)(oxo)niobium.

Optionally, the Nd source is one or more of neodymium oxide, neodymium chloride, neodymium hydroxide and neodymium fluoride.

Optionally, the La source is one or more of lanthanum oxide, lanthanum nitrate, lanthanum oxalate and lanthanum carbonate.

Optionally, the Ti source is one or more of titanium oxide, titanium chloride, sodium titanate and lithium titanate.

Optionally, the Ca source is one or more of calcium carbonate, calcium oxide, calcium hydroxide, calcium chloride and calcium nitrate.

Optionally, the Mn source is one or more of manganese chloride, manganese nitrate, manganese oxalate, manganese acetate, manganese sulfate and potassium permanganate.

Optionally, the Bi source is one or more of bismuth oxide, bismuth nitrate and bismuth sulfate.

Optionally, in Method I, the treating is performing ball milling, drying and calcining.

Optionally, in Method I, the ball milling comprises one of dry ball milling, wet ball milling, high-energy ball milling or cryo-ball milling.

Optionally, in Method I, the ball milling is performed at a rotational speed of 200-2000 rpm/min, such as 200 rpm/min, 300 rpm/min, 400 rpm/min or 500 rpm/min.

Optionally, in Method I, the ball milling is performed for a period of 2-48 h, such as 2 h, 10 h, 20 h, 30 h, 40 h or 48 h, optionally 2-12 h.

Optionally, in Method I, the drying comprises at least one of blast drying, vacuum drying or freeze drying.

Optionally, in Method I, the drying is performed at a temperature 60-120° C., such as 60° C., 70° C., 80° C., 90° C., 100° C., 110° C. or 120° C., and the drying is performed for a period of 8-24 h.

Optionally, in Method I, the calcining is performed at 500-900° C., such as 500° C., 600° C., 700° C., 800° C. or 900° C., and the calcining is performed for a period of 2-10 h, such as 2 h, 3 h, 4 h, 5 h, 6 h, 7 h, 8 h, 9 hor 10 h.

As an optional technical solution of the present application, the dispersing and treating in Method II comprises: ultrasonically dispersing the lithium-rich cathode material to obtain a dispersion solution, then dissolving the raw material of the n-type thermoelectric material in the dispersion solution, adding a chelating agent, heating and stirring, drying and then calcining to obtain the composite cathode material.

Optionally, in the dispersing and treating, the chelating agent comprises at least one of citric acid, sucrose, Span or oxalic acid.

Optionally, in the dispersing and treating, a solvent for the dispersion solution comprises at least one of water, ethanol or an aqueous solution of hydrogen peroxide.

Optionally, in the dispersing and treating, the heating is performed at a temperature of 40-100° C., such as 40° C., 50° C., 60° C., 70° C., 80° C., 90° C. or 100° C., optionally 50-80° C.

Optionally, the dispersing and treating, the stirring comprises magnetic stirring and/or mechanical stirring.

Optionally, in the dispersing and treating, the stirring is performed at a rotational speed of 200-500 rpm/min, such as 200 rpm/min, 300 rpm/min, 400 rpm/min or 500 rpm/min.

Optionally, in the dispersing and treating, the stirring is performed for a period of 2-8 h, such as 2 h, 3 h, 4 h, 5 h, 6 h, 7 h or 8 h.

Optionally, in the dispersing and treating, the drying comprises blast drying and/or vacuum drying.

Optionally, in the dispersing and treating, the drying is performed at a temperature of 80-150° C., such as 80° C., 100° C., 120° C., 140° C. or 150° C., and the drying is performed for a period of 5-20 h, such as 5 h, 10 h, 15 h or 20 h.

Optionally, in the dispersing and treating, the calcining is heating to 400-800° C., such as 400° C., 500° C., 600° C., 700° C. or 800° C., and sintering for 2-15 h, such as 2 h, 5 h, 10 h or 15 h, wherein a heating rate is 1-5° C./min, such as 1° C./min, 2° C./min, 3° C./min, 4° C./min or 5° C./min.

Optionally, in the dispersing and treating, the calcining is heating to 400-650° C. at a heating rate of 1-5° C./min and sintering for 2-10 h.

Optionally, in the dispersing and treating, the calcining is performed in an air atmosphere and/or an oxygen atmosphere.

As an optional technical solution of the present application, the dispersing and treating in Method II comprises: adding the raw material of the n-type thermoelectric material to the lithium-rich cathode material, ball milling, drying, and calcining, so as to obtain the composite cathode material.

Optionally, in the dispersing and treating, the ball milling comprises one of dry ball milling, wet ball milling, high-energy ball milling or cryo-ball milling.

Optionally, in the dispersing and treating, the ball milling is performed at a rotational speed of 200-2000 rpm/min, such as 200 rpm/min, 500 rpm/min, 1000 rpm/min, 1500 rpm/min or 2000 rpm/min.

Optionally, in the dispersing and treating, the ball milling is performed for a period of 2-48 h, such as 2 h, 10 h, 20 h, 30 h, 40 h or 48 h, optionally 2-12 h.

Optionally, in the dispersing and treating, the drying comprises at least one of blast drying, vacuum drying or freeze drying.

Optionally, in the dispersing and treating, the drying is performed at a temperature 60-120° C., such as 60° C., 70° C., 80° C., 90° C., 100° C., 110° C. or 120° C., and the drying is performed for a period of 8-24 h, such as 8 h, 10 h, 15 h, 20 h or 24 h.

Optionally, in the dispersing and treating, the calcining is performed at 500-900° C., such as 500° C., 600° C., 700° C., 800° C. or 900° C., and the calcining is performed for a period of 5-20 h, such as 5 h, 6 h, 7 h, 8 h, 9 h, 10 h, 12 h, 15 h, 18 h or 20 h.

As an optional technical solution for the preparation method of the present application, the method comprises the following steps:
(1) adding a chelating agent to a solution containing a lithium source, a manganese source and an M source to obtain a mixed solution, heating at 60-80° C. and stirring at a rotational speed 200-500 rpm for 4-8 h to obtain a sol, drying the sol at 80-150° C. for 5-20 h, heating to 350-650° C. at a heating rate of 1-2° C./min and sintering for 2-10 h, then heating to 800-950° C. at a heating rate of 3-8° C./min and sintering for 10-24 h, so as to obtain the lithium-rich cathode material; and
(2) ball milling and mixing a raw material of the n-type thermoelectric material at a rotational speed of 200-2000 rpm/min for 2-12 h, drying at 60-120° C. for 8-24 h, and calcining at 500-900° C. for 2-10 h, so as to obtain the n-type thermoelectric material; mixing the lithium-rich cathode material in step (1) with the n-type thermoelectric material, and ball milling at a rotational speed of 200-2000 rpm/min for 2-12 h, drying at 60-120° C. for 8-24 h, and calcining at 500-900° C. for 2-10 h, so as to obtain the composite cathode material;
or dispersing and treating the lithium-rich cathode material in step (1) and the raw material of the n-type thermoelectric material, so as to obtain the composite cathode material;
the dispersing and treating comprises: ultrasonically dispersing the lithium-rich cathode material to obtain a dispersion solution, then dissolving the raw material of the n-type thermoelectric material in the dispersion solution, adding a chelating agent, heating at 50-80° C. and stirring at a rotational speed of 200-500 rpm/min for 2-8 h, drying at 80-150° C. for 5-20 h, then heating to 400-650° C. at a heating rate of 1-5° C./min and sintering for 2-10 h, so as to obtain the composite cathode material;
or the dispersing and treating comprises: adding the raw material of the n-type thermoelectric material to the lithium-rich cathode material, ball milling at a rotational speed of 200-2000 rpm/min for 2-12 h, then drying at 60-120° C. for 8-24 h, and calcining at 500-900° C. for 5-20 h, so as to obtain the composite cathode material.

In a third aspect, the present application provides a lithium-ion battery, and the lithium-ion battery comprises the composite cathode material as described in the first aspect.

Compared with the prior art, the present application has the beneficial effects below.

(1) The composite cathode material provided in the present application is prepared by coating the lithium-rich cathode material with the n-type thermoelectric material, and at the same time, the heat generated by the lithium-rich cathode material via the metastable path is converted to a localized electric field, which reduces the driving force that drives the structural transformation of the lithium-rich manganese-based cathode material during the cyclic process, improves the structural stability, and thus improves the stability of electrochemical performance. The composite cathode material provided in the present application has an initial discharge specific capacity of up to 285 mAh·g⁻¹ and a capacity retention rate of up to 91%.

(2) The preparation method provided in the present application first utilizes the sol-gel method and, by adjusting the ratio of amine to amide in the chelating agent, in turn enables the lithium-rich cathode material to expose more (010) surfaces to facilitate lithium-ion diffusion.

### DETAILED DESCRIPTION

In order to better illustrate the present application and facilitate the understanding of the technical solutions of the present application, the present application will be described in further detail below. However, the following examples are only simple examples of the present application and do not represent or limit the protection scope of the present application, and the protection scope of the present application is defined by the claims.

The following are typical but non-limiting examples of the present application.

### Example 1

In this example, a composite cathode material is prepared by the following method.

(1) Preparation of a lithium-rich cathode material by a sol-gel method: lithium nitrate, manganese nitrate, nickel nitrate and cobalt nitrate were weighed out according to a molecular formula of Li_{1.2}Mn_{0.6}Ni_{0.15}Co_{0.05}O₂, i.e, a molar ratio of 1.2: 0.6: 0.15: 0.05, then dissolved in deionized water to form a mixed salt solution, and then added with N-isopropyl-2,4-dichlorobenzylamine and N,N-dimethylformamide according to a volume ratio of N-isopropyl-2,4-dichlorobenzylamine to N,N-dimethylformamide being 1:2, the reaction temperature was adjusted to 70° C., the system was reacted for 5 h by magnetic stirring at a rotational speed of 200 rpm to obtain a transparent viscous sol, the transparent viscous sol was dried at 140° C. for 12 h to obtain a dry sol, and the dry sol was heated to 200° C. at 5° C./min, then heated to 400° C. at 2° C./min, then heated to 600° C. at 1° C./min, kept at the temperature for 1 h, then heated to 900° C. at 5° C./min, and kept at the temperature for 12 h to obtain the lithium-rich cathode material.

(2) Preparation of a highly-stable lithium-rich cathode material by a ball milling method: lithium nitrate, phosphorus pentoxide and tris(nitrooxy)(oxo)niobium were added according to a molecular formula of Li_{0.3}P_{0.1}NbO₂ and mixed with the lithium-rich cathode material in step (1) at a coating amount of 5 wt. %, added with ethanol, ball-milled at 1000 rpm/min for 10 h, and then calcinated at 900° C. for 12 h to obtain the composite cathode material.

The composite cathode material prepared in this example comprises a core and a coating layer coated on the core, the core is the lithium-rich cathode material of Li_{1.2}Mn_{0.6}Co_{0.05}O₂, and the shell is Li_{0.3}P_{0.1}NbO₂ having lithium-ion diffusion channels. In the composite cathode material, a mass ratio of the n-type thermoelectric material to the lithium-rich cathode material is 3%.

### Example 2

In this example, a composite cathode material is prepared by the following method.

(1) Preparation of a lithium-rich cathode material by a sol-gel method: lithium acetate, manganese acetate, nickel acetate and cobalt acetate were weighed out according to a molecular formula of Li_{1.2}Mn_{0.55}Ni_{0.15}Co_{0.1}O₂, i.e, a molar ratio of 1.2: 0.55: 0.15: 0.1, then dissolved in deionized water to form a mixed salt solution, and then added with N-isopropyl-2,4-dichlorobenzylamine and N,N-dimethylacetamide according to a volume ratio of N-isopropyl-2,4-dichlorobenzylamine to N,N-dimethylacetamide being 1:3, the reaction temperature was adjusted to 80° C., the system was reacted for 6 h by magnetic stirring at a rotational speed of 500 rpm/min to obtain a transparent viscous sol, the transparent viscous sol was dried at 140° C. for 12 h to obtain a dry sol, and the dry sol was heated to 200° C. at 5° C./min, then heated to 400° C. at 2° C./min, then heated to 500° C. at 1° C./min, kept at the temperature for 2 h, then heated to 850° C. at 5° C./min, and kept at the temperature for 12 h to obtain the lithium-rich cathode material.

(2) Preparation of a highly-stable lithium-rich cathode material: lithium nitrate, neodymium oxide and titanium dioxide were added according to a molecular formula of (Nd_{1/3}Li)TiO₃ and mixed with the lithium-rich cathode material in step (1) at a coating amount of 5 wt. %, ball-milled at 500 rpm/min for 20 h, and then calcinated at 800° C. for 10 h to obtain the composite cathode material.

The composite cathode material prepared in this example comprises a core and a coating layer coated on the core, the core is the lithium-rich cathode material of Li_{1.2}Mn_{0.55}Ni_{0.15}Co_{0.1}O₂, and the shell is (Nd_{1/3}Li)TiO₃ having lithium-ion diffusion channels. In the composite cathode material, a mass ratio of the n-type thermoelectric material to the lithium-rich cathode material is 3%.

### Example 3

In this example, a composite cathode material is prepared by the following method.

(1) Preparation of a lithium-rich cathode material by a sol-gel method: lithium acetate, manganese acetate, nickel acetate and cobalt acetate were weighed out according to a molecular formula of Li_{1.2}Mn_{0.57}Ni_{0.08}Co_{0.15}O₂, i.e, a molar ratio of 1.2: 0.57: 0.08: 0.15, then dissolved in deionized water to form a mixed salt solution, and then added with N,N-dimethylhexahydro pyridine and N,N-dimethylformamide according to a volume ratio of N,N-dimethylhexahydro pyridine to N,N-dimethylformamide being 2:3, the reaction temperature was adjusted to 80° C., the system was reacted for 6 h by magnetic stirring at a rotational speed of 500 rpm to obtain a transparent viscous sol, the transparent viscous sol was dried at 140° C. for 12 h to obtain a dry sol, and the dry sol was heated to 200° C. at 5° C./min, then heated to 400° C. at 2° C./min, kept at the temperature for 2 h, then heated to 850° C. at 5° C./min, and kept at the temperature for 12 h to obtain the lithium-rich cathode material.

(2) Preparation of a highly-stable lithium-rich cathode material: calcium carbonate, manganese nitrate and bismuth nitrate were mixed according to a molecular formula of Ca_{0.99}Bi_{0.01}MnO₃, and the n-type Ca_{0.99}Bi_{0.01}MnO₃ material was mixed with the lithium-rich cathode material in step (1) at a coating amount of 5 wt. %, added with ethanol, ball-milled in liquid nitrogen at 500 rpm/min for 5 h, and then calcinated at 700° C. for 10 h to obtain the composite cathode material.

The composite cathode material prepared in this example comprises a core and a coating layer coated on the core, the core is the lithium-rich cathode material of Li_{1.2}Mn_{0.57}Ni_{0.08}Co_{0.15}O₂, and the shell is Ca_{0.99}Bi_{0.01}MnO₃ having lithium-ion diffusion channels. In the composite cathode material, a mass ratio of the n-type thermoelectric material to the lithium-rich cathode material is 3%.

### Example 4

In this example, a composite cathode material is prepared by the following method.

(1) Preparation of a lithium-rich cathode material by a sol-gel method: lithium chloride, manganese chloride, nickel chloride and cobalt chloride were weighed out according to a molecular formula of Li_{1.2}Mn_{0.64}Ni_{0.08}Co_{0.08}O₂, i.e, a molar ratio of 1.2: 0.64: 0.08: 0.08, then dissolved in deionized water to form a mixed salt solution, and then added with cyclohexanecarboxamide and N,N-dimethylformamide according to a volume ratio of cyclohexanecarboxamide to N,N-dimethylformamide being 1:3, the reaction temperature was adjusted to 70° C., the system was reacted for 6 h by magnetic stirring at a rotational speed of 500 rpm to obtain a transparent viscous sol, the transparent viscous sol was dried at 120° C. for 12 h to obtain a dry sol, and the dry sol was heated to 200° C. at 5° C./min, then heated to 400° C. at 2° C./min, then heated to 500° C. at 1° C./min, kept at the temperature for 2 h, then heated to 900° C. at 5° C./min, and kept at the temperature for 12 h to obtain the lithium-rich cathode material.

(2) Preparation of a highly-stable lithium-rich cathode material: calcium carbonate and manganese nitrate were mixed according to a molecular formula of CaMnO₃, ball-milled at 500 rpm/min for 5 h, and calcinated at 800° C. for 10 h to obtain an n-type CaMnO₃ material, the n-type CaMnO₃ material was mixed with the lithium-rich cathode material in step (1) at a coating amount of 5 wt. %, ball-milled at 500 rpm/min for 5 h, and then calcinated at 500° C. for 5 h to obtain the composite cathode material.

The composite cathode material prepared in this example comprises a core and a coating layer coated on the core, the core is the lithium-rich cathode material of Li_{1.2}Mn_{0.64}Ni_{0.08}Co_{0.08}O₂, and the shell is CaMnO₃ having lithium-ion diffusion channels. In the composite cathode material, a mass ratio of the n-type thermoelectric material to the lithium-rich cathode material is 5%.

### Example 5

In this example, a composite cathode material is prepared by the following method.

(1) Preparation of a lithium-rich cathode material by a first sol-gel method: lithium chloride, manganese chloride, nickel chloride and cobalt chloride were weighed out according to a molecular formula of Li_{1.2}Mn_{0.48}Ni_{0.16}Co_{0.16}O₂, i.e, a molar ratio of 1.2: 0.48: 0.16: 0.16, then dissolved in deionized water to form a mixed salt solution, and then added with cyclohexanecarboxamide and N,N-dimethylformamide according to a volume ratio of cyclohexanecarboxamide to N,N-dimethylformamide being 1:5, the reaction temperature was adjusted to 60° C., the system was reacted for 6 h by magnetic stirring at a rotational speed of 500 rpm to obtain a transparent viscous sol, the transparent viscous sol was dried at 140° C. for 12 h to obtain a dry sol, and the dry sol was heated to 200° C. at 5° C./min, then heated to 400° C. at 2° C./min, then heated to 500° C. at 1° C./min, kept at the temperature for 2 h, then heated to 900° C. at 5° C./min, and kept at the temperature for 12 h to obtain the lithium-rich cathode material.

(2) Preparation of a highly-stable lithium-rich cathode material by a second sol-gel method: the lithium-rich cathode material was dispersed in deionized water and subjected to ultrasonic treatment for 30 min, a coating amount was 5 wt. %, a mixed solution of calcium nitrate and manganese nitrate was prepared according to a molecular formula of CaMnO₃, a ratio of calcium nitrate to citric acid was 1:3, the mixed solution was stirred for 30 min and then added to the dispersion solution of the lithium-rich material, the reaction temperature was controlled at 80° C., the mixture was subjected to magnetic stirring for 2 h, and then placed into a vacuum oven and dried at 120° C. for 10 h, and then the dried powder was placed into a tube furnace, heated to 500° C. and kept at the temperature for 5 h, so as to obtain the composite cathode material.

The composite cathode material prepared in this example comprises a core and a coating layer coated on the core, the core is the lithium-rich cathode material of Li_{1.2}Mn_{0.48}Ni_{0.16}Co_{0.16}O₂, and the shell is CaMnO₃ having lithium-ion diffusion channels. In the composite cathode material, a mass ratio of the n-type thermoelectric material to the lithium-rich cathode material is 5%.

### Example 6

In this example, a composite cathode material is prepared by the following method.

(1) Preparation of a lithium-rich cathode material by a first sol-gel method: lithium chloride, manganese chloride, nickel chloride and cobalt chloride were weighed out according to a molecular formula of Li_{1.2}Mn_{0.48}Ni_{0.16}Co_{0.16}O₂, i.e, a molar ratio of 1.2: 0.48: 0.16: 0.16, then dissolved in deionized water to form a mixed salt solution, and then added with N,N-dimethylhexahydropyridine and succinimide according to a volume ratio of N,N-dimethylhexahydropyridine to succinimide being 1:3, the reaction temperature was adjusted to 60° C., the system was reacted for 5 h by magnetic stirring at a rotational speed of 500 rpm to obtain a transparent viscous sol, the transparent viscous sol was dried at 120° C. for 12 h to obtain a dry sol, and the dry sol was heated to 100° C. at 5° C./min, then heated to 300° C. at 2° C./min, then heated to 400° C. at 1° C./min, kept at the temperature for 2 h, then heated to 900° C. at 5° C./min, and kept at the temperature for 12 h to obtain the lithium-rich cathode material.

(2) Preparation of a lithium-rich cathode material by a second sol-gel method: the above lithium-rich cathode material was dispersed in deionized water and subjected to ultrasonic treatment for 30 min, a coating amount was 5 wt. %, calcium carbonate, manganese nitrate and bismuth oxide were prepared according to a molecular formula of Ca_{0.95}Bi_{0.05}MnO₃, and mixed with the lithium-rich cathode material in step (1) at a coating amount of 5 wt. %, ball-milled at 500 rpm/min for 5 h, and then calcinated at 800° C. for 10 h to obtain the composite cathode material.

The composite cathode material prepared in this example comprises a core and a coating layer coated on the core, the core is the lithium-rich cathode material of Li_{1.2}Mn_{0.48}Ni_{0.16}Co_{0.16}O₂, and the shell is Ca_{0.95}Bi_{0.05}MnO₃ having lithium-ion diffusion channels. In the composite cathode material, a mass ratio of the n-type thermoelectric material to the lithium-rich cathode material is 1%.

### Example 7

In this example, a composite cathode material is prepared by the following method.

(1) Preparation of a lithium-rich cathode material by a sol-gel method: lithium nitrate, manganese nitrate, nickel nitrate and aluminium nitrate were weighed out according to a molecular formula of Li_{1.2}Mn_{0.6}Ni_{0.15}Al_{0.05}O₂, i.e, a molar ratio of 1.2: 0.6: 0.15: 0.05, then dissolved in deionized water to form a mixed salt solution, and then added with citric acid, the reaction temperature was adjusted to 70° C., the system was reacted for 5 h by magnetic stirring at a rotational speed of 200 rpm to obtain a transparent viscous sol, the transparent viscous sol was dried at 140° C. for 12 h to obtain a dry sol, and the dry sol was heated to 200° C. at 5° C./min, then heated to 400° C. at 2° C./min, then heated to 600° C. at 1° C./min, kept at the temperature for 1 h, then heated to 900° C. at 5° C./min, and kept at the temperature for 12 h to obtain the lithium-rich cathode material.

(2) Preparation of a highly-stable lithium-rich cathode material by a ball milling method: lithium nitrate, phosphorus pentoxide and tris(nitrooxy)(oxo)niobium were added according to a molecular formula of Li_{0.1}P_{0.2}NbO₂ and mixed with the lithium-rich cathode material in step (1) at a coating amount of 5 wt. %, added with ethanol, ball-milled at 1000 rpm/min for 10 h, and then calcinated at 900° C. for 12 h to obtain the composite cathode material.

The composite cathode material prepared in this example comprises a core and a coating layer coated on the core, the core is the lithium-rich cathode material of Li_{1.2}Mn_{0.6}Ni_{0.15}Al_{0.05}O₂, and the shell is Li_{0.1}P_{0.2}NbO₂ having lithium-ion diffusion channels. In the composite cathode material, a mass ratio of the n-type thermoelectric material to the lithium-rich cathode material is 5%.

### Example 8

In this example, a composite cathode material is prepared by the following method.

(1) Preparation of a lithium-rich cathode material by a sol-gel method: lithium acetate, manganese acetate, nickel acetate and cobalt acetate were weighed out according to a molecular formula of Li_{1.2}Mn_{0.55}Ni_{0.15}Co_{0.1}O₂, i.e, a molar ratio of 1.2: 0.55: 0.15: 0.1, then dissolved in deionized water to form a mixed salt solution, and then added with N-isopropyl-2,4-dichlorobenzylamine and N,N-dimethylacetamide according to a volume ratio of N-isopropyl-2,4-dichlorobenzylamine to N,N-dimethylacetamide being 1:3, the reaction temperature was adjusted to 80° C., the system was reacted for 6 h by magnetic stirring at a rotational speed of 500 rpm/min to obtain a transparent viscous sol, the transparent viscous sol was dried at 140° C. for 12 h to obtain a dry sol, and the dry sol was heated to 200° C. at 5° C./min, then heated to 400° C. at 2° C./min, then heated to 500° C. at 1° C./min, kept at the temperature for 2 h, then heated to 850° C. at 5° C./min, and kept at the temperature for 12 h to obtain the lithium-rich cathode material.

(2) Preparation of a highly-stable cathode material by a ball milling method: lithium nitrate, neodymium oxide and titanium dioxide were added according to a molecular formula of (Nd_{0.8}Li_{1.5})TiO₃ and mixed with the lithium-rich cathode material in step (1) at a coating amount of 5 wt. %, ball-milled at 500 rpm/min for 20 h, and then calcinated at 800° C. for 10 h to obtain the composite cathode material.

The composite cathode material prepared in this example comprises a core and a coating layer coated on the core, the core is the lithium-rich cathode material of Li_{1.2}Mn_{0.55}Ni_{0.15}Co_{0.1}O₂, and the shell is (Nd_{0.8}Li_{1.5})TiO₃ having lithium-ion diffusion channels. In the composite cathode material, a mass ratio of the n-type thermoelectric material to the lithium-rich cathode material is 10%.

### Example 9

In this example, a composite cathode material is prepared by the following method.

(1) Preparation of a lithium-rich cathode material by a sol-gel method: lithium acetate, manganese acetate, nickel acetate and germanium nitrate were weighed out according to a molecular formula of Li_{1.2}Mn_{0.57}Ni_{0.08}Cr_{0.15}O₂, i.e, a molar ratio of 1.2: 0.57: 0.08: 0.15, then dissolved in deionized water to form a mixed salt solution, and then added with N,N-dimethylhexahydropyridine and N,N-dimethylformamide according to a volume ratio of N,N-dimethylhexahydropyridine to N,N-dimethylformamide being 2:3, the reaction temperature was adjusted to 80° C., the system was reacted for 6 h by magnetic stirring at a rotational speed of 500 rpm to obtain a transparent viscous sol, the transparent viscous sol was dried at 140° C. for 12 h to obtain a dry sol, and the dry sol was heated to 200° C. at 5° C./min, then heated to 400° C. at 2° C./min, kept at the temperature for 2 h, then heated to 850° C. at 5° C./min, and kept at the temperature for 12 h to obtain the lithium-rich cathode material.

(2) Preparation of a highly-stable lithium-rich cathode material: calcium chloride, bismuth nitrate and manganese nitrate were added according to a molecular formula of Ca_{0.9}Bi_{0.1}MnO₃ and mixed with the lithium-rich cathode material in step (1) at a coating amount of 5 wt. %, ball-milled in liquid nitrogen at 500 rpm/min for 5 h, and then calcinated at 700° C. for 10 h to obtain the composite cathode material.

The composite cathode material prepared in this example comprises a core and a coating layer coated on the core, the core is the lithium-rich cathode material of Li_{1.2}Mn_{0.57}Ni_{0.08}Cr_{0.15}O₂, and the shell is Ca_{0.9}Bi_{0.1}MnO₃ having lithium-ion diffusion channels. In the composite cathode material, a mass ratio of the n-type thermoelectric material to the lithium-rich cathode material is 5%.

### Example 10

In this example, a composite cathode material is prepared by the following method.

(1) Preparation of a lithium-rich cathode material by a sol-gel method: lithium chloride, manganese chloride, nickel chloride and cobalt chloride were weighed out according to a molecular formula of Li_{1.2}Mn_{0.64}Ni_{0.08}Mg_{0.04}O₂, i.e, a molar ratio of 1.2: 0.64: 0.08: 0.08, then dissolved in deionized water to form a mixed salt solution, and then added with citric acid, the reaction temperature was adjusted to 70° C., the system was reacted for 6 h by magnetic stirring at a rotational speed of 500 rpm to obtain a transparent viscous sol, the transparent viscous sol was dried at 120° C. for 12 h to obtain a dry sol, and the dry sol was heated to 200° C. at 5° C./min, then heated to 400° C. at 2° C./min, then heated to 500° C. at 1° C./min, kept at the temperature for 2 h, then heated to 900° C. at 5° C./min, and kept at the temperature for 12 h to obtain the lithium-rich cathode material.

(2) Preparation of a highly-stable lithium-rich cathode material: calcium carbonate and manganese nitrate were mixed according to a molecular formula of CaMnO₃, ball-milled at 500 rpm/min for 5 h, and calcinated at 800° C. for 10 h to obtain an n-type CaMnO₃ material, the n-type CaMnO₃ material was mixed with the lithium-rich cathode material in step (1) at a coating amount of 5 wt. %, ball-milled at 500 rpm/min for 5 h, and then calcinated at 500° C. for 5 h to obtain the composite cathode material.

The composite cathode material prepared in this example comprises a core and a coating layer coated on the core, the core is the lithium-rich cathode material of Li_{1.2}Mn_{0.64}Ni_{0.08}Mg_{0.04}O₂, and the shell is CaMnO₃ having lithium-ion diffusion channels. In the composite cathode material, a mass ratio of the n-type thermoelectric material to the lithium-rich cathode material is 4%.

### Example 11

This example differs from Example 1 in that the cobalt sulfate in step (1) was removed, and all the others are the same as those in Example 1.

The composite cathode material obtained in this example differs from the composite cathode material obtained in Example 1 in that the structural formula of the lithium-rich cathode material was Li_{1.2}Mn_{0.6}Ni_{0.2}O₂.

### Example 12

This example differs from Example 1 in that the ratio of N-isopropyl-2,4-dichlorobenzylamine to N,N-dimethylformamide was 3:1 in step (1), and all the others are the same as those in Example 1.

### Example 13

This example differs from Example 1 in that the ratio of N-isopropyl-2,4-dichlorobenzylamine to N,N-dimethylformamide was 1:3 in step (1), and all the others are the same as those in Example 1.

### Example 14

This example differs from Example 1 in that the reaction temperature was 60° C. in step (1), and all the others are the same as those in Example 1.

### Example 15

This example differs from Example 1 in that the last step of calcination in step (1) was performed at 800° C., and all the others are the same as those in Example 1.

### Example 16

This example differs from Example 1 in that the molecular formula in step (2) was Li_{0.2}P_{0.2}NbO₂, and all the others are the same as those in Example 1.

### Example 17

This example differs from Example 1 in that calcination in step (2) was performed at 400° C., and all the others are the same as those in Example 1.

The composite cathode material obtained in this example differs from the composite cathode material obtained in Example 1 in that a uniform coating layer was not formed.

### Example 18

This example differs from Example 1 in that calcination in step (2) was performed for 4 h, and all the others are the same as those in Example 1.

The composite cathode material obtained in this example differs from the composite cathode material obtained in Example 1 in that a uniform coating layer was not formed.

### Example 19

The composite cathode material provided in this example differs from the composite cathode material provided in Example 1 in that in the composite cathode material of this example, the mass ratio of the n-type thermoelectric material to the lithium-rich cathode material was 0.008:1.

### Example 20

The composite cathode material provided in this example differs from the composite cathode material provided in Example 1 in that in the composite cathode material of this example, the mass ratio of the n-type thermoelectric material to the lithium-rich cathode material was 0.06:1.

### Comparative Example 1

In this comparative example, only the lithium-rich cathode material obtained in step (1) of Example 1 was used in the test as the control.

Test method

The final product provided in each example or comparative example was used as a cathode active material and uniformly mixed with polyvinylidene fluoride (PVDF) and superconductive carbon black at a mass ratio of 8:1:1, and then N-methylpyrrolidone (NMP) was added to prepare a slurry, coated on an aluminium foil, and dried in vacuum to obtain a cathode sheet. A metal lithium plate was used as an anode, and the cathode, anode, electrolyte and separator were assembled into a button battery. The battery was subjected to a charge/discharge test with a voltage range of 2.0-4.8 V and a current density of 25 mA g⁻¹, and the initial discharge specific capacity and the capacity retention rate after 200 cycles of the battery were tested. The test results are shown in the table below.

TABLE 1

| | Initial discharge specific | Capacity retention |
|---|---|---|
| No. | capacity/mAh · g⁻¹ | rate (%) |
| Example 1 | 285 | 90 |
| Example 2 | 275 | 91 |
| Example 3 | 278 | 88 |
| Example 4 | 280 | 89 |
| Example 5 | 274 | 90 |
| Example 6 | 271 | 89 |
| Example 7 | 272 | 90 |
| Example 8 | 275 | 91 |
| Example 9 | 274 | 88 |
| Example 10 | 275 | 89 |
| Example 11 | 269 | 86 |
| Example 12 | 260 | 84 |
| Example 13 | 250 | 84 |
| Example 14 | 240 | 83 |
| Example 15 | 270 | 83 |
| Example 16 | 271 | 87 |
| Example 17 | 255 | 60 |
| Example 18 | 260 | 71 |
| Example 19 | 275 | 69 |
| Example 20 | 240 | 85 |
| Comparative | 270 | 40 |
| Example 1 | | |

By comprehensively analyzing the examples and comparative examples, it can be seen that the composite cathode materials provided in Examples 1-9 have excellent cycling performance.

In Example 11, the material stability is reduced because of the removal of cobalt.

In Example 12, because the chelating agent contains excessive amine (which has reached the boundary value of the preferred range), the material homogeneity is worse and in turn the cycle stability is worse.

In Example 13, because the chelating agent contains excessive amide (which has reached the boundary value of the preferred range) and the micro-composition of the material has been changed, the discharge specific capacity and cycle stability are reduced.

In Example 14, because the temperature of the heating reaction is reduced (which has reached the boundary value of the preferred range) which is unfavorable for particle collision and condensation, the discharge specific capacity is reduced.

In Example 15, because the calcination temperature is reduced (which has reached the boundary value of the preferred range), the solid-phase reaction is not sufficient, and the cycle stability is slightly reduced.

In Example 16, the thermoelectric material is different from that of Example 1, and the product performances are also different from those of Example 1.

In Example 17, because the calcination temperature is relatively low, the thermoelectric material is not formed, and the cycle stability is poor.

In Example 18, because the calcination period is relatively short, the thermoelectric material is not totally formed, and the cycle stability is poor.

In Example 19, because the n-type thermoelectric material is relatively low in content, the coating effect is uneven and the cycle stability is poor.

In Example 20, because the n-type thermoelectric material is relatively high in content, the initial discharge specific capacity is low.

In Comparative Example 1, because there is no n-type thermoelectric material to be combined, the cycle stability of the material is poor.

The applicant has stated that although the detailed methods of the present application are illustrated in terms of the above examples, the present application is not limited to the above examples, which means that the present application does not necessarily rely on the above detailed methods to be implemented.

1. A composite cathode material, comprising a core and a coating layer coated on the core, wherein the core comprises a lithium-rich cathode material, and the coating layer comprises an n-type thermoelectric material.

2. The composite cathode material according to claim 1, wherein the lithium-rich cathode material has a structural formula of xLi₂MnO₃-(1−x)LiMO₂, wherein M is any one or a combination of at least two of Co, Ni, Fe, K, V, Cr, Ge, Nb, Mo, Zr, Al, Sr, Mg or Ti, and 0<x≤1.

3. The composite cathode material according to claim 1, wherein the n-type thermoelectric material has lithium-ion diffusion channels.

4. The composite cathode material according to claim 2, wherein the M is a combination of Co, Ni and Mn.

5. The composite cathode material according to claim 1-4, wherein the n-type thermoelectric material comprises any one or a combination of at least two of LiₐP_{b}NbO₂, (Nd_{2/3-c}Li_{3c})TiO₃, (La_{2/3-c}Li_{3c})TiO₃ or CaₑBi_{f}MnO₃; wherein for the LiₐP_{b}NbO₂, and 0<b<0.2; for the (Nd_{2/3-c}Li_{3c})TiO₃ and (La_{2/3-c}Li_{3c})TiO₃, 0.2<c<2/3; for the CaₑBi_{f}MnO₃, 0.5<e≤1 and 0≤f<0.5;
optionally, a mass ratio of the n-type thermoelectric material to the lithium-rich cathode material is (0.01-0.5):1.

6. A preparation method for the composite cathode material according to claim 1, comprising the following steps:
combining the lithium-rich cathode material with the n-type thermoelectric material to obtain the composite cathode material;
a method of the combination comprises Method I: mixing the lithium-rich cathode material with the n-type thermoelectric material and treating, so as to obtain the composite cathode material;
or Method II: dispersing and treating the lithium-rich cathode material and a raw material of the n-type thermoelectric material, so as to obtain the composite cathode material.

7. The preparation method according to claim 6, wherein the preparation method comprises: adding a chelating agent to a solution containing a lithium source, a manganese source and an M source to obtain a mixed solution, heating and stirring to obtain a sol, and drying and calcining the sol to obtain the lithium-rich cathode material;
optionally, in the preparation method for the lithium-rich cathode material, a molar ratio of the lithium source to the manganese source to the M source is (1+x): x:(1−x), wherein 0<x≤1;
optionally, in the preparation method for the lithium-rich cathode material, the M source comprises any one or a combination of at least two of cobalt, nickel, iron, potassium, vanadium, chromium, germanium, niobium, molybdenum, zirconium, aluminium, strontium, magnesium or titanium;
optionally, the M source is any one or a combination of at least two of sulfate, chloride, acetate or nitrate;
optionally, in the preparation method for the lithium-rich cathode material, the lithium source comprises any one or a combination of at least two of lithium carbonate, lithium hydroxide, lithium nitrate or lithium acetate;
optionally, in the preparation method for the lithium-rich cathode material, the manganese source comprises any one or a combination of at least two of manganese chloride, manganese nitrate, manganese oxalate, manganese acetate, manganese sulfate or potassium permanganate;
optionally, in the preparation method for the lithium-rich cathode material, for the solution containing the lithium source, the manganese source and the M source, a solvent comprises any one or a combination of at least two of water, ethanol or an aqueous solution of hydrogen peroxide;
optionally, in the preparation method for the lithium-rich cathode material, the chelating agent is any one or a combination of at least two of amine, amide or citric acid, optionally a combination of amine and amide;
optionally, the amine comprises at least one of N-isopropyl-2,4-dichlorobenzylamine, cyclohexanecarboxamide or N,N-dimethylhexahydropyridine;
optionally, the amide is at least one of N,N-dimethylformamide, N,N-dimethylacetamide, succinimide or benzamide;
optionally, in the combination of amine and amide, a volume ratio of amine to amide is 1:3-3:1.

8. The preparation method according to claim 7, wherein, in the preparation method for the lithium-rich cathode material, the heating is performed at a temperature of 40-100° C., optionally 60-80° C.;
optionally, in the preparation method for the lithium-rich cathode material, the stirring is magnetic stirring and/or mechanical stirring;
optionally, in the preparation method for the lithium-rich cathode material, the stirring is performed at a rotational speed of 200-500 rpm/min;
optionally, in the preparation method for the lithium-rich cathode material, the stirring is performed for a period of 4-8 h;
optionally, in the preparation method for the lithium-rich cathode material, the drying comprises blast drying and/or vacuum drying;
optionally, in the preparation method for the lithium-rich cathode material, the drying is performed at a temperature of 80-150° C. for a period of 5-20 h;
optionally, in the preparation method for the lithium-rich cathode material, the calcining is heating to 200-700° C. at a heating rate of 1-10° C./min and sintering for 1-15 h, then heating to 800-1000° C. at a heating rate of 3-8° C./min and sintering for 10-24 h;
optionally, in the preparation method for the lithium-rich cathode material, the calcining is heating to 350-650° C. at a heating rate of 1-2° C./min and sintering for 2-10 h, then heating to 800-950° C. at a heating rate of 3-8° C./min and sintering for 10-24 h;
optionally, in the preparation method for the lithium-rich cathode material, the calcining is performed in an air atmosphere and/or an oxygen atmosphere.

9. The preparation method according to claim 6, wherein, in Method I, a preparation method for the n-type thermoelectric material comprises:
ball milling and mixing a raw material of the n-type thermoelectric material, drying, and calcining, so as to obtain the n-type thermoelectric material;
optionally, in the preparation method for the n-type thermoelectric material, the ball milling comprises one of dry ball milling, wet ball milling, high-energy ball milling or cryo-ball milling;
optionally, in the preparation method for the n-type thermoelectric material, the ball milling is performed at a rotational speed of 200-2000 rpm/min;
optionally, in the preparation method for the n-type thermoelectric material, the ball milling is performed for a period of 2-48 h, optionally 2-12 h;
optionally, in the preparation method for the n-type thermoelectric material, the drying comprises at least one of blast drying, vacuum drying or freeze drying;
optionally, in the preparation method of the n-type thermoelectric material, the drying is performed at a temperature of 60-120° C. for a period of 8-24 h;
optionally, in the preparation method for the n-type thermoelectric material, the calcining is performed at 500-900° C. for 2-10 h;
optionally, in Method I, the treating is performing ball milling, drying and calcining;
optionally, in Method I, the ball milling comprises one of dry ball milling, wet ball milling, high-energy ball milling or cryo-ball milling;
optionally, in Method I, the ball milling is performed at a rotational speed of 200-2000 rpm/min;
optionally, in Method I, the ball milling is performed for a period of 2-48 h, optionally 2-12 h;
optionally, in Method I, the drying comprises at least one of blast drying, vacuum drying or freeze drying;
optionally, in Method I, the drying is performed at a temperature 60-120° C. for a period of 8-24 h;
optionally, in Method I, the calcining is performed at 500-900° C. for 2-10 h.

10. The preparation method according to claim 6, wherein the dispersing and treating in Method II comprises: ultrasonically dispersing the lithium-rich cathode material to obtain a dispersion solution, then dissolving the raw material of the n-type thermoelectric material in the dispersion solution, adding a chelating agent, heating and stirring, drying and then calcining to obtain the composite cathode material;
optionally, in the dispersing and treating, the chelating agent comprises at least one of citric acid, sucrose, Span or oxalic acid;
optionally, in the dispersing and treating, a solvent for the dispersion solution comprises at least one of water, ethanol or an aqueous solution of hydrogen peroxide;
optionally, in the dispersing and treating, the heating is performed at a temperature of 40-100° C., optionally 50-80° C.;
optionally, the dispersing and treating, the stirring comprises magnetic stirring and/or mechanical stirring;
optionally, in the dispersing and treating, the stirring is performed at a rotational speed of 200-500 rpm/min;
optionally, in the dispersing and treating, the stirring is performed for a period of 2-8 h;
optionally, in the dispersing and treating, the drying comprises blast drying and/or vacuum drying;
optionally, in the dispersing and treating, the drying is performed at a temperature of 80-150° C. for a period of 5-20 h;
optionally, in the dispersing and treating, the calcining is heating to 400-800° C. at a heating rate of 1-5° C./min and sintering for 2-15 h;
optionally, in the dispersing and treating, the calcining is heating to 400-650° C. at a heating rate of 1-5° C./min and sintering for 2-10 h;
optionally, in the dispersing and treating, the calcining is performed in an air atmosphere and/or an oxygen atmosphere.

11. The preparation method according to claim 6, wherein the dispersing and treating in Method II comprises: adding the raw material of the n-type thermoelectric material to the lithium-rich cathode material, ball milling, drying, and calcining, so as to obtain the composite cathode material;
optionally, in the dispersing and treating, the ball milling comprises one of dry ball milling, wet ball milling, high-energy ball milling or cryo-ball milling;
optionally, in the dispersing and treating, the ball milling is performed at a rotational speed of 200-2000 rpm/min;
optionally, in the dispersing and treating, the ball milling is performed for a period of 2-48 h, optionally 2-12 h;
optionally, in the dispersing and treating, the drying comprises at least one of blast drying, vacuum drying or freeze drying;
optionally, in the dispersing and treating, the drying is performed at a temperature 60-120° C. for a period of 8-24 h;
optionally, in the dispersing and treating, the calcining is performed at 500-900° C. for 5-20 h.

12. The preparation method according to claim 6, comprising the following steps:
(1) adding a chelating agent to a solution containing a lithium source, a manganese source and an M source to obtain a mixed solution, heating at 60-80° C. and stirring at a rotational speed 200-500 rpm for 4-8 h to obtain a sol, drying the sol at 80-150° C. for 5-20 h, heating to 350-650° C. at a heating rate of 1-2° C./min and sintering for 2-10 h, then heating to 800-950° C. at a heating rate of 3-8° C./min and sintering for 10-24 h, so as to obtain the lithium-rich cathode material; and
(2) ball milling and mixing a raw material of the n-type thermoelectric material at a rotational speed of 200-2000 rpm/min for 2-12 h, drying at 60-120° C. for 8-24 h, and calcining at 500-900° C. for 2-10 h, so as to obtain the n-type thermoelectric material; mixing the lithium-rich cathode material in step (1) with the n-type thermoelectric material, and ball milling at a rotational speed of 200-2000 rpm/min for 2-12 h, drying at 60-120° C. for 8-24 h, and calcining at 500-900° C. for 2-10 h, so as to obtain the composite cathode material;
or dispersing and treating the lithium-rich cathode material in step (1) and the raw material of the n-type thermoelectric material, so as to obtain the composite cathode material;
the dispersing and treating comprises: ultrasonically dispersing the lithium-rich cathode material to obtain a dispersion solution, then dissolving the raw material of the n-type thermoelectric material in the dispersion solution, adding a chelating agent, heating at 50-80° C. and stirring at a rotational speed of 200-500 rpm/min for 2-8 h, drying at 80-150° C. for 5-20 h, then heating to 400-650° C. at a heating rate of 1-5° C./min and sintering for 2-10 h, so as to obtain the composite cathode material;
or the dispersing and treating comprises: adding the raw material of the n-type thermoelectric material to the lithium-rich cathode material, ball milling at a rotational speed of 200-2000 rpm/min for 2-12 h, then drying at 60-120° C. for 8-24 h, and calcining at 500-900° C. for 5-20 h, so as to obtain the composite cathode material.

13. A lithium-ion battery, which comprises the composite cathode material according to claim 1.
